(19) United States
(12) Patent Application Publication
(10) Pub. No.: US 2024/0243379 A1
(43) Pub. Date: Jul. 18, 2024

(54) REDUCTION ROASTING DEVICE AND METHOD FOR RECOVERING LITHIUM FROM WASTE LITHIUM BATTERY

(71) Applicants: NANCHANG HANGKONG UNIVERSITY, Nanchang City (CN); JIANGXI HUANLI NEW ENERGY TECHNOLOGY CO., LTD., Yichun City (CN); SHANGRAO HUANLI RECYCLING TECHNOLOGY CO., LTD., Shangrao City (CN)

(72) Inventors: Guisheng ZENG, Nanchang City (CN); Jia HU, Nanchang City (CN); Liang XU, Nanchang City (CN); Jianbin XU, Nanchang City (CN); Chunli LIU, Nanchang City (CN); Junwei HE, Nanchang City (CN); Jinxiang YU, Nanchang City (CN)

(21) Appl. No.: 18/471,774

(22) Filed: Sep. 21, 2023

(30) Foreign Application Priority Data
Jan. 16, 2023 (CN) 202310060194.3

(51) Int. Cl. H01M 10/54; C22B 3/22; C22B 5/02; C22B 7/00; C22B 26/12

(52) U.S. Cl. CPC H01M 10/54; C22B 3/22; C22B 5/02; C22B 7/006; C22B 26/12

(57) ABSTRACT

Disclosed are a reduction roasting device and a method for recovering lithium from a waste lithium battery. The reduction roasting device includes a microporous slide (1), a quartz tube (3), a vertical tube furnace (7), a protective gas cylinder (5-1), and a reducing gas cylinder (5-2), wherein the protective gas cylinder (5-1) and the reducing gas cylinder (5-2) are each in communication with a bottom of the quartz tube (3); the quartz tube (3) is placed inside the vertical tube furnace (7); and the microporous slide (1) is located inside a chamber (3-1) of the quartz tube (3), and a diameter direction of the microporous slide (1) is perpendicular to a length direction of the chamber (3-1) of the quartz tube (3).

### CROSS REFERENCE TO RELATED APPLICATION

This patent application claims the benefit and priority of Chinese Patent Application No. 2023100601943, entitled “Reduction roasting device and method for recovering lithium from waste lithium battery” filed on Jan. 16, 2023, the disclosure of which is incorporated by reference herein in its entirety as part of the present application.

### TECHNICAL FIELD

The present disclosure relates to the technical field of lithium battery recovery technology, in particular to a reduction roasting device and a method for recovering lithium from a waste lithium battery.

### BACKGROUND ART

Lithium-ion battery products, including mobile phones, cars, and digital products, have become necessities in people's daily lives. Based on the overall evolution and average lifespan of the global lithium battery market, it is expected that the final amount of battery materials recovered globally by 2035 will be equivalent to approximately 104 GWh. If not properly treated or disposed of, these large amounts of waste will pose serious risks to the environment. The lithium-ion battery industry continues to consume a large number of metal materials. In order to achieve sustainable development of the lithium-ion battery industry, it is urgent to develop economically feasible and environmentally friendly methods to separate and recover lithium from waste lithium-ion batteries.

At present, the main methods for recovering lithium resources include chemical leaching, biological extraction, heat treatment, and mechanochemistry. For chemical leaching, the key to metal recovery is to separate out metal elements from cathode materials of waste lithium batteries. To achieve this goal, strong acids are widely used to dissolve metal elements. However, the potential environmental risks caused by strong acids greatly limit their large-scale application. In addition, biological extraction and mechanochemistry could achieve efficient separation of metal elements, but their processing capacity is too low to treat large-scale waste lithium-ion batteries. Relatively speaking, traditional heat treatment could effectively treat a large number of waste lithium-ion batteries and separate out metal elements. However, after this, a series of complex purification processes are required to obtain metal products. Therefore, in addition to improving the recovery rate of lithium ions, how to improve the selectivity of lithium in the metal extraction process is also a key point, because the selective recovery of lithium could greatly simplify the recovery process and reduce chemical consumption to meet the huge social needs.

To solve the above problem, Chinese patent application No. CN202210234652.6 discloses “Method for carbon reduction-roast recovery of ternary cathode waste”. In the method, a reducing atmosphere is provided by roasting with carbon, and then the ternary cathode waste is subjected to reduction roasting; leaching is performed by adding a reduced powder to pure water; a filtration is performed; lime milk is added to a leachate; and a resulting mixture is heated until the mixture boils, to obtain lithium hydroxide. Although CN202210234652.6 realizes the purpose of preferentially extracting lithium, the use of carbon as a reducing agent may introduce new impurities (carbon), which increases the difficulty of subsequent processes, and carbon as a reducing agent may lead to incomplete recovery of lithium (<90%), and additional reagents need to be added to the leachate to obtain lithium hydroxide. Also, a problem of insufficient contact between the reducing gas and the cathode active material generally occurs when a reducing atmosphere is used to react with the cathode active material of waste lithium batteries, causing inefficient utilization of the reducing gas and waste of resources.

### SUMMARY

An object of the present disclosure is to provide a reduction roasting device and a method for recovering lithium from a waste lithium battery. The reduction roasting device enables the efficient utilization of the reducing gas. The method for recovering lithium from a waste lithium battery has characteristics of high recovery rate, low-carbon and clean.

In order to achieve the above object, the present disclosure provides the following technical solutions:

The present disclosure provides a reduction roasting device, including a microporous slide 1, a quartz tube 3, a vertical tube furnace 7, a protective gas cylinder 5-1, and a reducing gas cylinder 5-2, wherein the protective gas cylinder 5-1 and the reducing gas cylinder 5-2 are each in communication with a bottom of the quartz tube 3; the quartz tube 3 is placed inside the vertical tube furnace 7; and the microporous slide 1 is located inside a chamber 3-1 of the quartz tube 3, and a diameter direction of the microporous slide 1 is perpendicular to a length direction of the chamber 3-1 of the quartz tube 3.

In some embodiments, the microporous slide 1 is a quartz sand core plate with a pore size of 40-100 μm.

The present disclosure further provides a method for recovering lithium from a waste lithium battery, including the steps: withdrawing a cathode active substance from the waste lithium battery; subjecting the cathode active substance to reduction roasting in the reduction roasting device as described in above technical solutions, to obtain a reduced powder; and performing leaching by soaking the reduced powder in water to obtain a mixture, filtering the mixture to obtain a filtrate, and subjecting the filtrate to crystallization, to obtain lithium hydroxide.

In some embodiments, subjecting the cathode active substance to reduction roasting includes the steps: placing the cathode active substance on the microporous slide 1 in the quartz tube 3, and placing the quartz tube 3 in a vertical tube furnace 7; introducing a protective gas from the protective gas cylinder 5-1 into the chamber 3-1 of the quartz tube 3 for ventilation; raising a temperature in the quartz tube 3 to a reduction roast temperature, and stopping introducing the protective gas; and introducing a reducing gas from the reducing gas cylinder 5-2 into the chamber 3-1 of the quartz tube 3, and subjecting the cathode active substance to reduction roasting.

In some embodiments, the protective gas includes one or more selected from the group consisting of argon gas, nitrogen gas, and helium gas; and the reducing gas comprises one or more selected from the group consisting of ammonia gas and hydrogen gas.

In some embodiments, raising the temperature in the quartz tube (3) to the reduction roast temperature is performed at a rate 2-10° C./min.

In some embodiments, the reduction roasting is performed at a temperature of 300-750° C. for 30-120 minutes, with a reducing gas flow of 50-400 mL/min.

In some embodiments, the leaching is performed at a liquid-solid ratio of 10-150 mL/g and a temperature of 20-60° C. for 10-60 minutes.

In some embodiments, withdrawing the cathode active substance from the waste lithium battery includes the steps: subjecting the waste lithium battery to discharge, disassembly, and drying in sequence, to obtain cathode plates; and subjecting the cathode plates to roasting, stripping, and sieving in sequence, to obtain the cathode active substance.

In some embodiments, the roasting is performed at a temperature of 550-700° C. for 30-90 minutes.

The present disclosure provides a reduction roasting device, including a microporous slide 1, a quartz tube 3, a vertical tube furnace 7, a protective gas cylinder 5-1, and a reducing gas cylinder 5-2, wherein the protective gas cylinder 5-1 and the reducing gas cylinder 5-2 are each in communication with a bottom of the quartz tube 3; the quartz tube 3 is placed inside the vertical tube furnace 7; and the microporous slide 1 is located inside a chamber 3-1 of the quartz tube 3, and a diameter direction of the microporous slide 1 is perpendicular to a length direction of the chamber 3-1 of the quartz tube 3. The reduction roasting device could make sample's collection and placement more convenient, and make the reducing gas completely pass through the material to be reduced, such that the material to be reduced more fully contact with the reducing gas, which enables more efficient utilization of the reducing atmosphere, and more complete reaction, thereby improving the recovery efficiency.

The present disclosure also provides a method for recovering lithium from a waste lithium battery, including the following steps: withdrawing a cathode active substance from the waste lithium battery; subjecting the cathode active substance to reduction roasting in the reduction roasting device as described in the above technical solutions to obtain a reduced powder; and performing leaching by soaking the reduced powder to obtain a mixture, filtering the mixture to obtain a filtrate, and subjecting the filtrate to crystallization, to obtain lithium hydroxide. The method for recovering lithium in the disclosure residues in first subjecting the cathode active substance to reduction roasting, and then performing leaching by soaking a reduced powder obtained in pure water. During the leaching, the leaching of nickel, cobalt, manganese and other valuable metal elements is inhibited, while the lithium element is dissolved in water, so that the lithium element in the cathode material of the waste lithium battery is selectively leached out. The obtained filtrate is subjected to crystallization to obtain lithium hydroxide. The leaching rate of lithium element could reach 99%, and the selectivity of lithium could reach 99%. Therefore, the method according to the present disclosure achieves high extraction rate and high selectivity, and has simple process. Moreover, the recovery process described in the present disclosure does not require the addition of additional toxic and harmful chemical reagents. Although the reduction roasting process produces exhaust gas, the recovery process of the exhaust gas is relatively mature. Specifically, the exhaust gas could be absorbed sequentially by conventional acid and alkali solutions, and therefore the recovery process is efficient, clean, and environmentally friendly. Since lithium oxide and the elementary substances or oxides of nickel, cobalt and manganese would be generated in the process of reduction roasting, water is selected in the present disclosure as the leaching agent for selectively leaching out lithium. Lithium oxide is soluble in water to generate lithium hydroxide, while the elementary substances or oxides of nickel, cobalt and manganese are not soluble in water, so lithium is leached out while the leaching of nickel, cobalt and manganese is inhibited. Also, the leaching process is simple, costs less time, and achieves selective extraction of lithium in one step.

### BRIEF DESCRIPTION OF THE DRAWINGS

FIG. 1 shows a schematic diagram of the structure of the reduction roasting device according to an embodiment of the present disclosure, in which 1 represents a microporous slide; 2 represents a ground mouth; 3 represents a quartz tube; 3-1 represent a chamber of the quartz tube 3; 4 represents a vent valve; 5-1 represents a protective gas cylinder; 5-2 represents a reducing gas cylinder; 6 represents an exhaust gas absorption liquid; and 7 represents a vertical tube furnace.

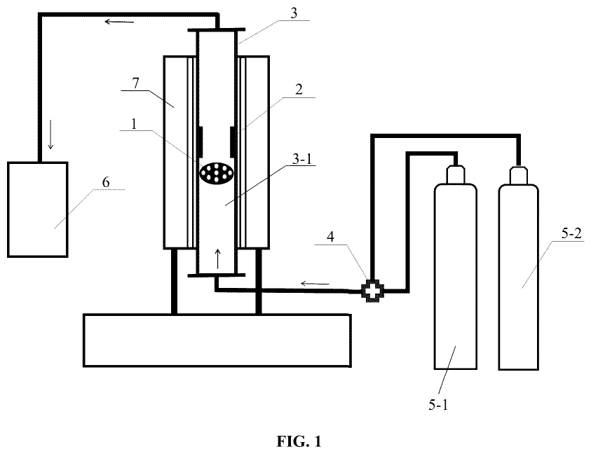

FIG. 2 shows a flowchart of the method for recovering lithium from a waste lithium battery according to an embodiment of the present disclosure.

### DETAILED DESCRIPTION OF THE EMBODIMENTS

The present disclosure provides a reduction roasting device, including a microporous slide 1, a quartz tube 3, a vertical tube furnace 7, a protective gas cylinder 5-1, and a reducing gas cylinder 5-2, wherein the protective gas cylinder 5-1 and the reducing gas cylinder 5-2 are each in communication with a bottom of the quartz tube 3; the quartz tube 3 is placed inside the vertical tube furnace 7; and the microporous slide 1 is located inside a chamber 3-1 of the quartz tube 3, and a diameter direction of the microporous slide 1 is perpendicular to a length direction of the chamber 3-1 of the quartz tube 3.

In some embodiments of the present disclosure, the reduction roasting device further includes an exhaust gas absorption liquid 6, which is connected to the top of the quartz tube 3 for absorbing the exhaust gas generated during the reduction roasting process.

In some embodiments of the present disclosure, the reduction roasting device further includes a vent valve 4, which is a three-way valve; and the three-way connectors of the vent valve are respectively connected to the bottom of the quartz tube 3, a protective gas cylinder 5-1, and a reducing gas cylinder 5-2.

In some embodiments of the present disclosure, the quartz tube 3 has a ground mouth 2.

In some embodiments, the microporous slide 1 is a quartz sand core plate with a pore size of 40-100 μm.

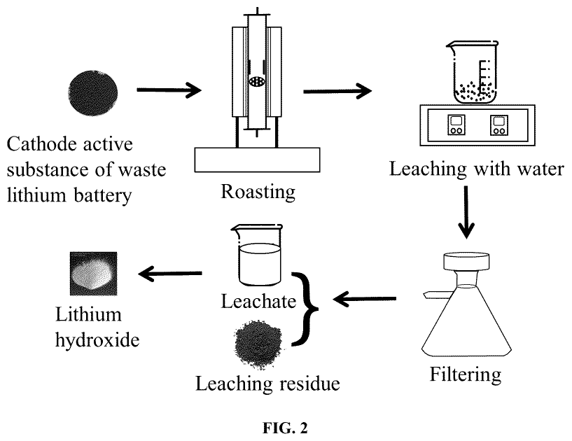

As shown in FIG. 2, the present disclosure further provides a method for recovering lithium from a waste lithium battery, including the steps: withdrawing a cathode active substance from the waste lithium battery; subjecting the cathode active substance to reduction roasting in the reduction roasting device as described in above technical solutions, to obtain a reduced powder; and performing leaching by soaking the reduced powder in water to obtain a mixture, filtering the mixture to obtain a filtrate, and subjecting the filtrate to crystallization, to obtain lithium hydroxide.

In the present disclosure, unless otherwise specified, all raw materials for preparation are well-known commercially available products for those skilled in the art.

In the method according to the present disclosure, a cathode active substance is withdrawn from a waste lithium battery.

In some embodiments, withdrawing the cathode active substance from the waste lithium battery includes the steps: subjecting the waste lithium battery to discharge, disassembly, and drying in sequence, to obtain cathode plates; and subjecting the cathode plates to roasting, stripping, and sieving in sequence, to obtain the cathode active substance.

In some embodiments, the waste lithium battery is subjected to discharge, disassembly, and drying in sequence, to obtain cathode plates.

In the present disclosure, there is no special limitation on the processes of discharge, disassembly, and drying, and the processes well-known to those skilled in the art may be adopted.

In some embodiments of the present disclosure, after obtaining the cathode plates, the cathode plates are subjected to roasting, stripping, and sieving, to obtain the cathode active substance.

In some embodiments, the roasting is performed at a temperature of 550-700° C., preferably 580-670° C., and more preferably 600-630° C. In some embodiments, the roasting is performed for 30-90 minutes, preferably 40-80 minutes, and more preferably 50-60 minutes.

In the present disclosure, the roasting is to remove the electrolyte and adhesive carried on the cathode plates, and to make it easier to strip off the cathode active substance from the aluminum foil.

In the present disclosure, there is no special limitation on the process of stripping and sieving, and a process well-known to those skilled in the art may be adopted.

In some embodiments of the present disclosure, the cathode active substance after sieving has a particle size of 25-400 μm, preferably 40-200 μm, and more preferably 45-100 μm.

In the method according to the present disclosure, after obtaining the cathode active substance, the cathode active substance is subjected to reduction roasting in the reduction roasting device as described in the above technical solutions to obtain a reduced powder.

In some embodiments of the present disclosure, subjecting the cathode active substance to reduction roasting includes placing the cathode active substance on the microporous slide 1 in the quartz tube 3, and placing the quartz tube 3 in a vertical tube furnace 7; introducing a protective gas from the protective gas cylinder 5-1 into the chamber 3-1 of the quartz tube 3 for ventilation; raising a temperature in the quartz tube 3 to a reduction roast temperature, and stopping introducing the protective gas; and introducing a reducing gas from the reducing gas cylinder 5-2 into the chamber 3-1 of the quartz tube 3, and subjecting the cathode active substance to reduction roasting.

In some embodiments of the present disclosure, the protective gas comprises one or more of argon gas, nitrogen gas, and helium gas, and preferably nitrogen gas. Under the condition that the protective gas is more than two of the specific choices mentioned above, there is no special limitation on the proportions of specific substances mentioned above, and a mixture of any ratio may be used. In some embodiments, the reducing gas includes ammonia gas and/or hydrogen gas, and preferably hydrogen gas. Under the condition that the reducing gas is ammonia gas and hydrogen gas, there is no any special limitation on proportions of the ammonia gas and hydrogen gas, and any proportions may be adopted.

In some embodiments of the present disclosure, the temperature in the quartz tube is raised to the reduction roast temperature at a rate 2-10° C./min, preferably 3-7° C./min, and more preferably 4-5° C./min.

In some embodiments of the present disclosure, the reduction roasting is performed at a temperature of 300-750° C., preferably 400-700° C., and more preferably 500-600° C. In some embodiments, the reduction roasting is performed for 30-120 minutes, preferably 40-100 minutes, and more preferably 50-60 minutes. In some embodiments, a flow of the reducing gas is in a range of 50-400 mL/min, preferably 100-300 mL/min, and more preferably 150-250 mL/min.

In the method according to the present disclosure, after obtaining the reduced powder, the leaching is performed by soaking the reduced powder in water to obtain a mixture; the mixture is filtered to obtain a filtrate; the filtrate is subjected to crystallization, to obtain lithium hydroxide.

In some embodiments of the present disclosure, the leaching is performed at a liquid-solid ratio of 10-150 mL/g, preferably 30-110 mL/g, and more preferably 50-80 mL/g. In some embodiments, the leaching is performed at a temperature of 20-60° C., preferably 30-50° C., and more preferably 35-45° C. In some embodiments, the leaching is performed for 10-60 minutes, preferably 20-50 minutes, and more preferably 30-40 minutes.

In the method according to the present disclosure, after the leaching, filtration is performed. In the present disclosure, there is no special limitation on the filtration process, and a process well-known to those skilled in the art may be adopted.

In some embodiments, the method further includes, before the crystallization, concentrating the filtrate under a reduced pressure. In the present disclosure, there is no special limitation on the process of concentration under a reduced pressure, and a process well-known to those skilled in the art may be adopted.

In the present disclosure, there is no special limitation on the crystallization process, and a process well-known to those skilled in the art may be adopted.

The reduction roasting device and the method for recovering lithium from a waste lithium battery according to the present disclosure will be described in detail below, in conjunction with examples. However, these examples cannot be understood as limiting the scope of the present disclosure.

### Example 1

The reduction roasting device includes microporous slide 1, quartz tube 3, vertical tube furnace 7, protective gas cylinder 5-1, and reducing gas cylinder 5-2, wherein the protective gas cylinder 5-1 and the reducing gas cylinder 5-2 are each in communication with a bottom of the quartz tube 3; and the microporous slide 1 is located inside the chamber 3-1 of the quartz tube 3 and is able to be taken out. The reduction roasting device is a vertical reduction roasting device. The reduction roasting device further includes an exhaust gas absorption liquid 6, which is connected to the top of the quartz tube 3. The reduction roasting device also includes a vent valve 4, which is a three-way valve. The three-way connectors of the vent valve are respectively connected to the bottom of the quartz tube 3, a protective gas cylinder 5-1, and a reducing gas cylinder 5-2. The quartz tube 3 has a ground mouth 2. The microporous slide 1 is a quartz sand core plate with a pore size of 60 μm.

The waste lithium-ion battery (lithium cobalt oxide battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 600° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 200 mL/min), and the ground cathode active substance was subjected to reduction roasting for 60 minutes, obtaining a reduced powder.

The reduced powder was placed into pure water for leaching. The leaching was performed at a liquid-solid ratio of 100 mL/g and a temperature of 35° C. for 25 minutes. The resulting mixture was filtered (the filter residues were cobalt and cobalt oxide). The filtrate obtained was sequentially subjected to concentration under a reduced pressure and crystallization, obtaining lithium hydroxide.

### Example 2

The reduction roasting device is the same as described in Example 1.

The waste lithium-ion battery (lithium cobalt oxide battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 700° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 150 mL/min), and the ground cathode active substance was subjected to reduction roasting for 60 minutes, obtaining a reduced powder.

The reduced powder was placed into pure water for leaching. The leaching was performed at a liquid-solid ratio of 100 mL/g and a temperature of 30° C. for 30 minutes. The resulting mixture was filtered (the filter residues were cobalt and cobalt oxide). The filtrate obtained was sequentially subjected to concentration under a reduced pressure and crystallization, obtaining lithium hydroxide.

### Example 3

The reduction roasting device is the same as described in Example 1.

The waste lithium-ion battery (lithium cobalt oxide battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 500° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 200 mL/min), and the ground cathode active substance was subjected to reduction roasting for 30 minutes, obtaining a reduced powder.

The reduced powder was placed into pure water for leaching. The leaching was performed at a liquid-solid ratio of 100 mL/g and a temperature of 30° C. for 30 minutes. The resulting mixture was filtered (the filter residues were cobalt and cobalt oxide). The filtrate obtained was sequentially subjected to concentration under a reduced pressure and crystallization, obtaining lithium hydroxide.

### Example 4

The reduction roasting device is the same as described in Example 1.

The waste lithium-ion battery (lithium cobalt oxide battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 550° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 100 mL/min), and the ground cathode active substance was subjected to reduction roasting for 60 minutes, obtaining a reduced powder.

The reduced powder was placed into pure water for leaching. The leaching was performed at a liquid-solid ratio of 100 mL/g and a temperature of 35° C. for 30 minutes. The resulting mixture was filtered (the filter residues were cobalt and cobalt oxide). The filtrate obtained was sequentially subjected to concentration under a reduced pressure and crystallization, obtaining lithium hydroxide.

### Example 5

The reduction roasting device is the same as described in Example 1.

The waste lithium-ion battery (lithium nickel cobalt manganese oxide battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 650° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 200 mL/min), and the ground cathode active substance was subjected to reduction roasting for 60 minutes, obtaining a reduced powder.

The reduced powder was placed into pure water for leaching. The leaching was performed at a liquid-solid ratio of 100 mL/g and a temperature of 35° C. for 30 minutes. The resulting mixture was filtered (the filter residue were nickel, cobalt, manganese, and oxides thereof). The filtrate obtained was sequentially subjected to concentration under a reduced pressure and crystallization, obtaining lithium hydroxide.

### Example 6

The reduction roasting device is the same as described in Example 1.

The waste lithium-ion battery (lithium nickel cobalt manganese oxide battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 700° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 150 mL/min), and the ground cathode active substance was subjected to reduction roasting for 60 minutes, obtaining a reduced powder.

The reduced powder was placed into pure water for leaching. The leaching was performed at a liquid-solid ratio of 100 mL/g and a temperature of 35° C. for 30 minutes. The resulting mixture was filtered (the filter residues were nickel, cobalt, manganese, and oxides thereof). The filtrate obtained was sequentially subjected to concentration under a reduced pressure and crystallization, obtaining lithium hydroxide.

### Example 7

The reduction roasting device is the same as described in Example 1.

The waste lithium-ion battery (lithium nickel cobalt manganese oxide battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 750° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 200 mL/min), and the ground cathode active substance was subjected to reduction roasting for 40 minutes, obtaining a reduced powder.

The reduced powder was placed into pure water for leaching. The leaching was performed at a liquid-solid ratio of 100 mL/g and a temperature of 35° C. for 30 minutes. The resulting mixture was filtered (the filter residues were nickel, cobalt, manganese, and oxides thereof). The filtrate obtained was sequentially subjected to concentration under a reduced pressure and crystallization, obtaining lithium hydroxide.

### Example 8

The reduction roasting device was the same as described in Example 1.

The waste lithium-ion battery (lithium manganate battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 650° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 200 mL/min), and the ground cathode active substance was subjected to reduction roasting for 60 minutes, obtaining a reduced powder.

The reduced powder was placed into pure water for leaching. The leaching was performed at a liquid-solid ratio of 100 mL/g and a temperature of 35° C. for 30 minutes. The resulting mixture was filtered (the filter residues were nickel, cobalt, manganese, and oxides thereof). The filtrate obtained was sequentially subjected to concentration under a reduced pressure and crystallization, obtaining lithium hydroxide.

### Example 9

The reduction roasting device is the same as described in Example 1.

The waste lithium-ion battery (lithium nickel oxide battery) was subjected to discharge, disassembly, and drying, obtaining cathode plates.

After being roasted at 550° C. for 60 minutes, the cathode plates were stripped out and sieved sequentially, obtaining the cathode active substance with a particle size less than 75 μm.

The cathode active substance was fully ground, and the ground cathode active substance was placed on the microporous slide inside the quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 650° C. at a rate of 10° C./min, and then the introduction of the argon gas was stopped. Ammonia gas from the reducing gas cylinder 5-2 was introduced into the chamber 3-1 of the quartz tube 3 (the flow of the ammonia gas was 200 mL/min), and the ground cathode active substance was subjected to reduction roasting for 60 minutes, obtaining a reduced powder.

The reduced powder was placed into pure water for leaching. The leaching was performed at a liquid-solid ratio of 100 mL/g and a temperature of 35° C. for 30 minutes. The resulting mixture was filtered (the filter residues were nickel, cobalt, manganese, and oxides thereof). The filtrate obtained was sequentially subjected to concentration under a reduced pressure and crystallization, obtaining lithium hydroxide.

### Comparative Example 1

This comparative example was performed according to procedures as described in Example 1, except that the ammonia gas atmosphere during the reduction roasting was replaced by the oxygen gas atmosphere.

### Comparative Example 2

This comparative example was performed according to procedures as described in Example 1, except that the ammonia gas atmosphere during the reduction roasting was replaced by the air atmosphere.

### Comparative Example 3

This comparative example was performed according to procedures as described in Example 1, except that the ammonia gas atmosphere during the reduction roasting was replaced by the nitrogen gas atmosphere.

### Comparative Example 4

This comparative example was performed according to procedures as described in Example 1, except for the following procedures:

the cathode active substance was ground, and the ground cathode active substance was then placed on a microporous slide inside a quartz tube; the quartz tube was placed in the vertical tube furnace 7. Argon gas from the protective gas cylinder 5-1 was introduced into the chamber 3-1 of the quartz tube 3 for ventilation. The temperature in the quartz tube was raised to 300° C. at a rate of 10° C./min, and then the introduction of argon gas was stopped. Ammonia gas from the reducing gas cylinder 5-2 was introduced into the chamber 3-1 of the quartz tube 3 (the flow of the ammonia gas was 200 mL/min), and the ground cathode active substance was subjected to reduction roasting for 40 minutes, obtaining a reduced powder.

### Comparative Example 5

This comparative example was performed according to procedures as described in Example 1, except for the following procedures:

the cathode active substance was ground, and the ground cathode active substance was then placed in an aluminum oxide ark; the aluminum oxide ark was then placed in a horizontal tube furnace. In the protective atmosphere of argon gas, the temperature in the aluminum oxide ark was raised to 700° C. at a rate of 10° C./min, and then the introduction of argon gas was stopped. Ammonia gas was immediately introduced (the flow of the ammonia gas was 200 mL/min), and the ground cathode active substance was reacted for 60 minutes, obtaining a reduced powder.

### Comparative Example 6

This comparative example was performed according to procedures as described in Example 1, except for the following procedures:

the cathode active substance was ground, and the ground cathode active substance was then placed in an aluminum oxide ark; the aluminum oxide ark was placed in a horizontal tube furnace. In the protective atmosphere of argon gas, the temperature in the aluminum oxide ark was raised to 750° C. at a rate of 10° C./min, and then the introduction of argon gas was stopped. Ammonia gas was immediately introduced (the flow of the ammonia gas was 200 mL/min), and the ground cathode active substance was reacted for 40 minutes, obtaining a reduced powder.

### Test Example

Cathode active substances before reaction in Examples 1 to 9 and Comparative Examples 1 to 6 were digested with aqua regia (the volume ratio of hydrochloric acid to nitric acid was 3:1) respectively, and then the lithium concentrations C1 in these cathode active substances before reaction were measured by using ICP Inductively coupled plasma emission spectrometer. The lithium concentrations C2 in the filtrates obtained after leaching were also measured by using ICP Inductively coupled plasma emission spectrometer. The leaching rate was calculated according to the equation: Leaching rate=(C2×V2)/(C1×V1), where V1 represents the volume of the cathode active substance after being digested and diluted to a certain volume but before reaction, and V2 represents the volume of the filtrate after leaching. The leaching rate results are shown in Table 1.

TABLE 1
Leaching rate of lithium in Examples 1-9 and
Comparative Examples 1-6

| Example No. | Leaching rate of lithium/% |
|---|---|
| Example 1 | 99.26 |
| Example 2 | 99.93 |
| Example 3 | 71.21 |
| Example 4 | 75.09 |
| Example 5 | 92.62 |
| Example 6 | 98.36 |
| Example 7 | 99.55 |
| Example 8 | 99.21 |
| Example 9 | 98.83 |
| Comparative Example 1 | 3.06 |
| Comparative Example 2 | 6.36 |
| Comparative Example 3 | 4.28 |
| Comparative Example 4 | 20.68 |
| Comparative Example 5 | 55.79 |
| Comparative Example 6 | 58.91 |

As can be seen from Table 1, the leaching rate of lithium in Examples 1 to 9 is not less than 70%, among which the leaching rates of lithium in Examples 2 and 7 are as high as 99.93% and 99.55%, respectively. By comparing Examples 1-9 with Comparative Examples 1-6, it can be seen that the leaching rate of lithium in Examples 1-9 is significantly higher than that in Comparative Example 1 (the atmosphere was oxygen gas during roasting), Comparative Example 2 (the atmosphere was air during roasting), Comparative Example 3 (the atmosphere was nitrogen gas during roasting), and Comparative Example 4 (roast temperature was 300° C.), Comparative Example 5 (lithium cobalt oxide cathode powder was placed and roasted in an aluminum oxide ark in a horizontal tube furnace), and Comparative Example 6 (lithium cobalt oxide cathode powder was placed and roasted in an aluminum oxide ark in a horizontal tube furnace). This indicates that, the method according to the present disclosure could enable the reduction atmosphere to fully contact and react with the waste lithium battery cathode powder by selecting appropriate reduction atmosphere, reduction temperature, suitable leaching agent, and appropriate reduction-roast system, achieving efficient roasting effect. Therefore, the valuable metal element lithium in the waste cathode lithium battery material could be fully leached out, while the leaching of nickel, cobalt, and manganese is inhibited, which improves the leaching rate of lithium and enables selective leaching of lithium, thereby achieving green, efficient, and highly selective extraction of lithium.

The method according to the present disclosure has the same applicability for lithium cobalt oxide, lithium manganate, lithium nickel oxide, and ternary lithium batteries.

The above are only the preferred embodiments of the present disclosure. It should be pointed out that for ordinary artisans in the art, several improvements and embellishments could be made without departing from the principles of the present disclosure. These improvements and embellishments should also be considered as falling within the scope of the present disclosure.

What is claimed is:

1. A reduction roasting device, comprising a microporous slide (1), a quartz tube (3), a vertical tube furnace (7), a protective gas cylinder (5-1), and a reducing gas cylinder (5-2),
wherein the protective gas cylinder (5-1) and the reducing gas cylinder (5-2) are each in communication with a bottom of the quartz tube (3);
the quartz tube (3) is placed inside the vertical tube furnace (7); and
the microporous slide (1) is located inside a chamber (3-1) of the quartz tube (3), and a diameter direction of the microporous slide (1) is perpendicular to a length direction of the chamber (3-1) of the quartz tube (3).

2. The reduction roasting device as claimed in claim 1, wherein the microporous slide (1) is a quartz sand core plate with a pore size of 40-100 μm.

3. A method for recovering lithium from a waste lithium battery, comprising the steps of
withdrawing a cathode active substance from the waste lithium battery;
subjecting the cathode active substance to reduction roasting in the reduction roasting device as claimed in claim 1, to obtain a reduced powder; and
performing leaching by soaking the reduced powder in water, to obtain a mixture, filtering the mixture to obtain a filtrate, and subjecting the filtrate to crystallization, to obtain lithium hydroxide.

4. The method as claimed in claim 3, wherein subjecting the cathode active substance to reduction roasting comprises the steps of
placing the cathode active substance on the microporous slide (1) in the quartz tube (3), and placing the quartz tube (3) in a vertical tube furnace (7);
introducing a protective gas from the protective gas cylinder (5-1) into the chamber (3-1) of the quartz tube (3) for ventilation;
raising a temperature in the quartz tube (3) to a reduction roast temperature, and stopping introducing the protective gas; and
introducing a reducing gas from the reducing gas cylinder (5-2) into the chamber (3-1) of the quartz tube (3), and subjecting the cathode active substance to reduction roasting.

5. The method as claimed in claim 4, wherein the protective gas comprises one or more selected from the group consisting of argon gas, nitrogen gas, and helium gas; and
the reducing gas comprises one or more selected from the group consisting of ammonia gas and hydrogen gas.

6. The method as claimed in claim 4, wherein raising the temperature in the quartz tube (3) to the reduction roast temperature is performed at a rate 2-10° C./min.

7. The method as claimed in claim 4, wherein the reduction roasting is performed at a temperature of 300-750° C. for 30-120 minutes, with a reducing gas flow of 50-400 m/min.

8. The method as claimed in claim 3, wherein the leaching is performed at a liquid-solid ratio of 10-150 mL/g and a temperature of 20-60° C. for 10-60 minutes.

9. The method as claimed in claim 3, wherein withdrawing the cathode active substance from the waste lithium battery comprises the steps of
subjecting the waste lithium battery to discharge, disassembly, and drying in sequence, to obtain cathode plates; and
subjecting the cathode plates to roasting, stripping, and sieving in sequence, to obtain the cathode active substance.

10. The method as claimed in claim 9, wherein the roasting is performed at a temperature of 550-700° C. for 30-90 minutes.

11. The method as claimed in claim 5, wherein the reduction roasting is performed at a temperature of 300-750° C. for 30-120 minutes, with a reducing gas flow of 50-400 m/min.

12. The method as claimed in claim 6, wherein the reduction roasting is performed at a temperature of 300-750° C. for 30-120 minutes, with a reducing gas flow of 50-400 m/min.
